(19) United States
(12) Patent Application Publication
(10) Pub. No.: US 2011/0202183 A1
(43) Pub. Date: Aug. 18, 2011

(54) CONTROL DEVICE

(76) Inventor: Steven John Hardman, Essex (GB)

(21) Appl. No.: 13/124,011

(22) PCT Filed: Oct. 14, 2009
(86) PCT No.: PCT/GB09/51374

§ 371 Date: Apr. 13, 2011

(30) Foreign Application Priority Data
Oct. 14, 2008 (GB) 0818867.4

(51) Int. Cl. G06F 1/32; G05D 23/19; G06F 1/28

(52) U.S. Cl. 700/276

(57) ABSTRACT

The invention is a device (10,50) for automatically controlling an electrical item (11,51) which is operable by a wireless control unit (12,52) adapted to issue a control signal (14,65) corresponding to a particular command. The device (10,50) comprises a first sensing means (21) for detecting a first predetermined condition and issuing a first output signal indicative of said first predetermined condition being satisfied. It also includes means (32,33,34,36,37,38) for learning and storing the control signal (14,65) issued by the wireless control unit (12,52) which corresponds to the particular command. A transmitter (32,37) is provided selectively to transmit an emulated control signal (27,35) matching that of the stored control signal on receipt of the output signal indicating the satisfaction of the first predetermined condition. For instance, the predetermined condition may be the absence of someone in the vicinity of the electrical item (11,51) and if that condition is satisfied the emulated signal may be transmitted to turn off the electrical item. The control device (10,50) may also be adapted to determine the operational status of an electrical item and transmit the emulated signal (27,35) if that status satisfies a second predetermined condition. This feature is particularly useful when the particular command is conveyed by a control signal (65) that also conveys another command and the electrical item (51) responds to the command that is appropriate to its operational status.

The present invention relates to a device for wirelessly controlling an electrical item and in particular to a device for automatically controlling an electrical item in response to a predetermined condition being satisfied.

Many domestic, commercial and industrial items are often left on continuously or for long periods thus unnecessarily leading to large amounts of energy being wasted. Nowadays society is becoming increasingly concerned about using energy sensibly and conservatively, particularly due to its rising costs, its impact on the environment and the diminishing supply of fossil fuels. Also, many electrical items have a limited life expectancy or cycle before replacement or servicing is required, thus providing a further impetus to avoid using those items unnecessarily.

For instance, many offices and homes have air conditioning systems that run continuously regardless of whether anybody is in the vicinity to benefit from the cool air or heat generated. Similarly, entertainment systems such as televisions, radios and other audio equipment are often left switched on in unoccupied homes, canteens or waiting rooms. Under certain circumstances it would be desirable to switch off the item while in other circumstances it might be preferable merely to adjust the audio output of the item. A simple solution to turn off an electrical item automatically is simply to provide a device between the appliance and the mains power source which can break the circuit therebetween in response to the detection of the area being unoccupied. Such a device might include a motion sensor circuit that drives a relay for electrically connecting and disconnecting the electrical power to the appliance.

However, this solution has many shortcomings and is therefore of limited use. In particular, it permits binary control of the item between on and off states and does not facilitate adjustment of different parameters on a variable level. In some instances it may not be desirable to turn an air conditioning unit off, but rather maintain the area in the vicinity of the unit at a slightly warmer, but still bearable temperature should anybody return. Similarly, it may be desirable to reduce the audio volume of a television in response to sustained background noise.

Some electrical items include a shutdown program to de-energise any vulnerable components therein which program may take only several seconds and is activated automatically when the item is switched off in the prescribed manner. Specifically, some items include mechanical systems that must be left in a state of equilibrium when not in use. Notably these include some air conditioning units which require the refrigerant in the system to equalise when not in use. In view of this, the disconnection of the item from the mains power supply in a manner other than that prescribed by the manufacturer could be detrimental and should be avoided.

It is an object of the present invention to provide a mechanism for automatic control of an electrical item in response to a predetermined condition being satisfied. It is a further object of this invention to control an electrical item in a prescribed manner and not merely by disconnecting it from the mains power supply. It is yet a further object of this invention to provide a controller that may be used with any wirelessly controlled electrical item without any complex reprogramming or rewiring being required.

According to a first aspect of the invention, there is provided a device for automatically controlling an electrical item which is operable by a wireless control unit adapted to issue a control signal corresponding to a particular command, the device comprising:
a first sensing means for detecting a first predetermined condition and issuing a first output signal indicative of said first predetermined condition being satisfied;
means for learning and storing the control signal issued by the wireless control unit which corresponds to the particular command; and
a transmitter adapted selectively to transmit an emulated control signal matching that of the stored control signal on receipt of the first output signal indicating the satisfaction of the first predetermined condition.

Preferably the control signal comprises electromagnetic radiation in the infrared or radio wave spectral ranges. In one embodiment the means for learning and storing the control signal include a receiver circuit adapted to receive the signal and a memory adapted to store defining characteristics of that signal sufficient for its regeneration. In an alternative embodiment the means for learning and storing the control signal include data entry means for inputting defining characteristics of the control signal and a memory for storing those characteristics. The means for learning and storing may be capable of learning and storing more than one control signal.

In one arrangement the first predetermined condition is the absence or the presence of a person or animal in a defined area and the first sensing means comprise a motion sensor adapted selectively to detect one of those first predetermined conditions. The motion sensor may comprise a passive device such as a passive infrared (PIR) sensor adapted to sense motion in its viewing field. Typically these operate by detecting, within the viewing field, when one infrared source with one temperature passes another infrared source of a different temperature such that the temperature difference generates a voltage. These are widely available and are common knowledge to the skilled addressee so no further explanation of those is provided here. Alternatively or additionally the sensing means include an active device comprising a transmitter arranged to transmit microwaves or ultrasonic waves and a receiver that receives the reflected waves, the presence of a person or animal in the viewing field disturbs the normal reflectance pattern. Again, this technology is well known so no further explanation of that is necessary here.

In one arrangement the first sensing means is adapted to operate intermittently such that it operates for a predetermined period for a preset number of times per hour. This is particularly advantageous when the sensing means includes an active device, which would consume a considerable amount of energy when run continuously.

In a preferred arrangement there is provided second sensing means for detecting the operational status of the electrical item and the transmission of the emulated control signal also depends on said operational status. This feature is particularly useful for various reasons. For example, some electrical items may have a remote control unit which transmits a first control signal corresponding to more than one command and the operational status of that electrical item determines whether it responds to that control signal. The emulated signal may correspond to the power on command and the power off command of an electrical item such as a television or air conditioning unit. Advantageously, the second sensing means may include a preset condition comprising one of an on state and an off state and the transmitter is permitted to transmit the emulated signal only when the operational status of the electrical item is in the other of the on state and the off state. In this way, if the second sensing means has been configured such that its preset condition is the off state and the emulated signal corresponds to the power on and power off commands of a television, the emulated signal will be transmitted only when the television is in the on state. Without this feature the emulated signal would be transmitted when the television is in the off state potentially causing the television to switch on.

In one embodiment the second sensing means is adapted to determine the power consumed by the electrical item which is indicative of the operational status of the electrical item. Preferably the second sensing means comprises an electrical input for connection to an electrical power supply and an electrical output for connection to the electrical item and a power consumption detector. The power consumption detector may be configured to determine the magnitude of the current drawn by the electrical item connected to the electrical output.

Additionally or alternatively the second sensing means may be adapted to determine the temperature or vibration characteristics of the electrical item by preferably including a thermometer or accelerometer. These types of sensing means are preferably located in close proximity to the electrical item and most preferably they are mounted in or on the electrical item.

Furthermore, the second sensing means may be adapted to detect noise or sound emanating from the electrical item and may include a microphone for this purpose. Most electrical circuits generate some kind of noise and this is particularly so during use as the electrons flow through the conductors. Thus noise can be detected periodically and compared to a threshold value corresponding to, for example, the maximum level of noise generated by the electrical item when in its off state. If the detected noise exceeds that threshold value then the electrical item is likely to be in its on state and the emulated signal can be transmitted. Conversely if the noise does not exceed that value then the electrical item is in the off state and transmission of the emulated signal can be prevented.

In one embodiment the control unit can be used to adjust the volume of audio equipment in response to changing levels of background noise, which is particularly useful in waiting rooms, canteens and so forth. In this embodiment the first sensing means is adapted to determine the magnitude of any background noise in the vicinity of the electrical item and the second sensing means is adapted to determine the magnitude of any noise emitted from the electrical item. The first predetermined condition is that the sum of the background noise and a preset value exceeds the noise emitted from the electrical item and a second predetermined condition is that the sum of the noise emitted from the electrical item and the preset value exceeds the background noise. The preset value, the background noise and the noise emitted from the electrical item are preferably all measured in decibels. The preset value is selected according to the required difference between the background noise and the sound of the electrical item for the sound of the electrical item to be comfortably heard. There is also provided means for learning and storing a second control signal and the transmitter is adapted to transmit the first emulated control signal when the first predetermined condition is satisfied and to transmit the second emulated control signal when the second predetermined condition is satisfied. The first emulated control signal may correspond to an audio volume-up command issued by the wireless control unit and the second emulated control signal may correspond to an audio volume-down command issued by the wireless control unit.

Preferably the present invention includes a housing in which the various components can be mounted and which has windows transparent to the control signals and emulated signals. In one embodiment the housing is also adapted to accommodate the first sensing means and may, if required, include an aperture or window so that the characteristic being detected may be sensed. In another embodiment the first sensing means is detached from the housing to facilitate location remote from the housing.

In a second aspect of the invention there is provided a method of controlling an electrical item operable by a wireless control unit, comprising the steps of:
a) recording a first control signal corresponding to a particular command and issued by the wireless control unit;
b) Monitoring for a first predetermined condition; and
c) on detection of the predetermined condition transmitting an emulated signal equivalent to the first control signal so as to present the electrical item with the particular command.

This method may also include steps of determining the operational status of the electrical item and transmitting the emulated signal only if that status corresponds to a preset condition.

By way of example on, two embodiments of the present invention will now be described in detail, with reference being made to the accompanying drawings, in which:

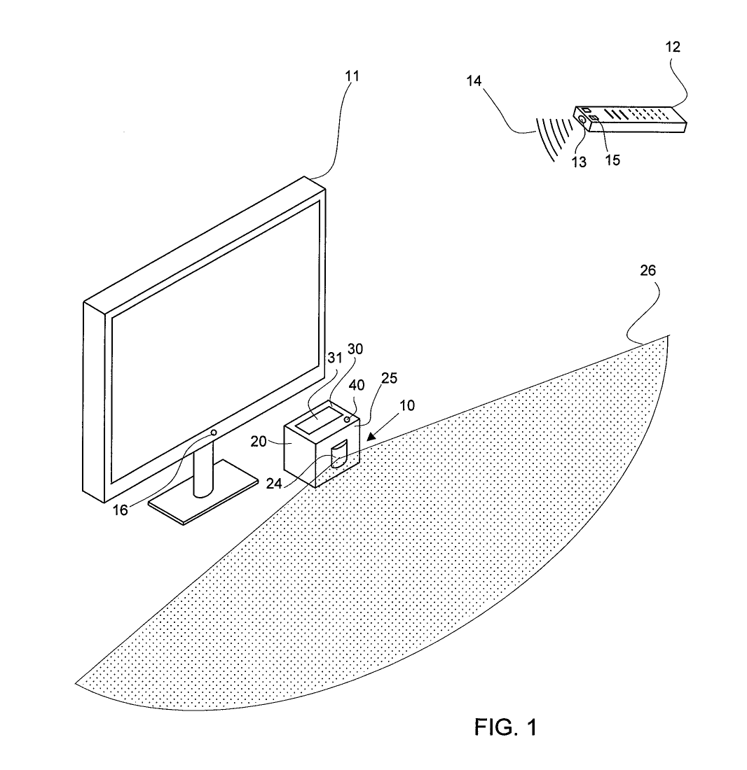

FIG. 1 is a perspective view of a first embodiment of the invention electrically connected to a television;

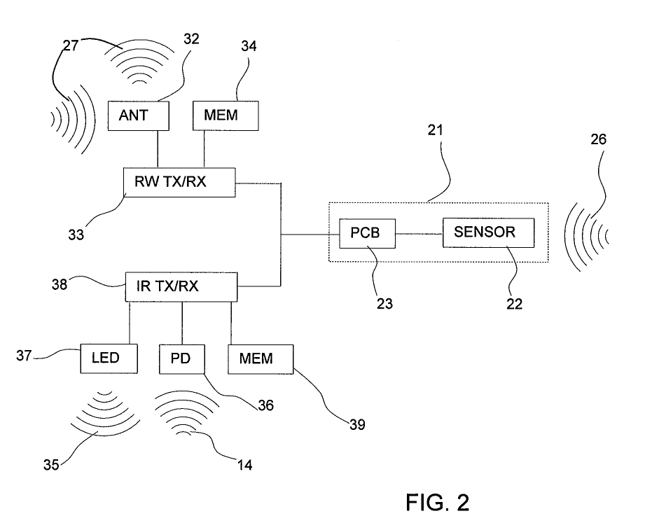

FIG. 2 is a schematic diagram of the first embodiment as shown in FIG. 1;

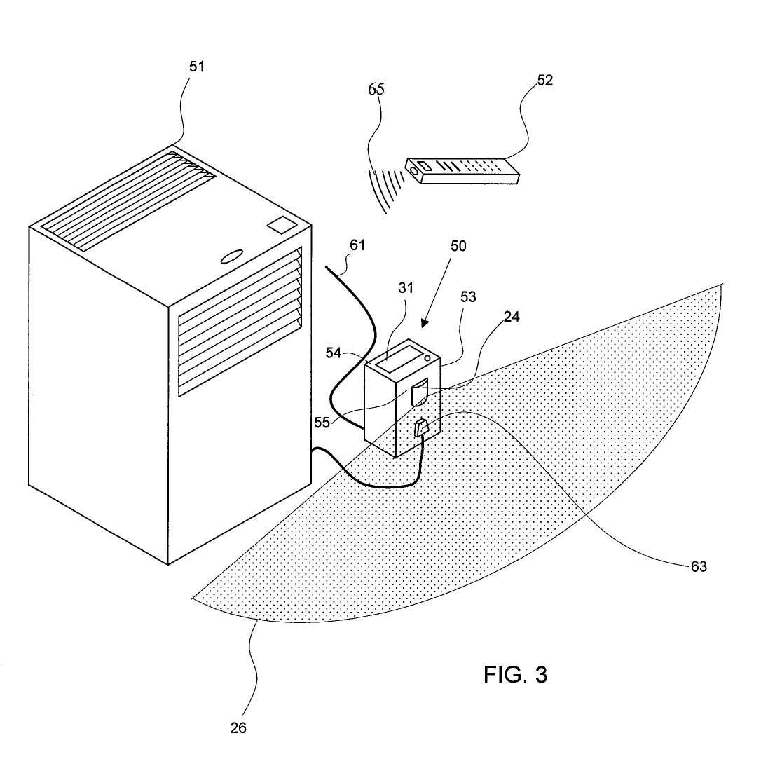

FIG. 3 is a perspective view of a second embodiment of the invention electrically connected to an air conditioning unit;

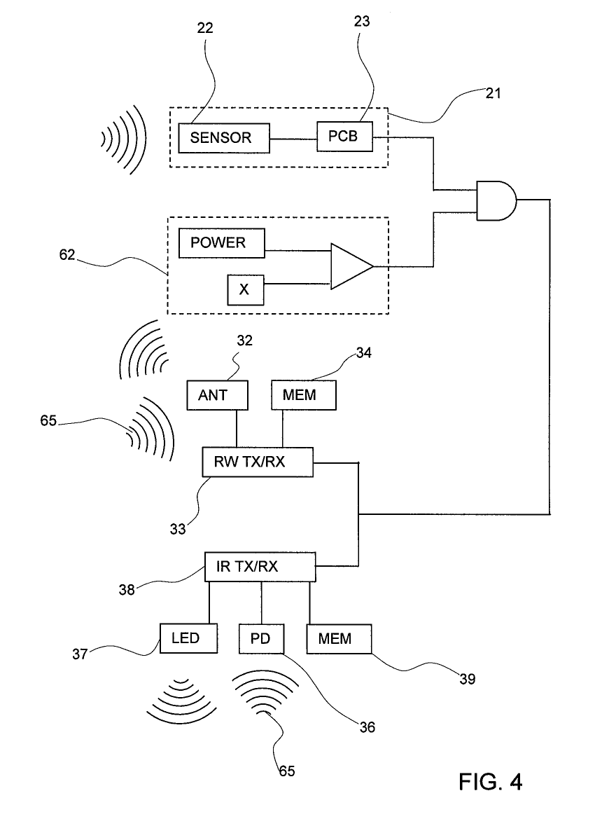

FIG. 4 is a schematic diagram of the second embodiment as shown in FIG. 3; and

Referring initially to FIGS. 1 and 2, there is shown a control device, generally indicated 10, for wirelessly communicating with a television 11 and the television's handset 12. The handset has a light emitting diode (LED) 13 for transmitting an infrared signal 14 and many buttons each labelled with a particular command, such that when a particular command is required the corresponding button is pressed which causes the LED to transmit a specific infrared signal. The top left button 15 is labelled with the command OFF and when pressed an infrared signal specific to that command is transmitted. The television 11 includes a photodiode 16 for receiving the infrared signal 14 issued by the handset 12 and appropriate circuitry to demodulate those signals.

The control device includes a housing 20 in which there is provided a passive infrared detector (PID) 21 comprising a sensor 22 mounted on a PCB 23 configured to analyse the signals from the sensor. In this instance the sensor is made from pyroelectric material which generates a temporary electrical potential when heated or cooled, which is interpreted by the PCB 23. A lens 24 transparent to infrared radiation 14 is provided on the front face 25 of the housing which in combination with the sensor 22 defines a field of view 26. The housing is positioned such that the lens 24 disposed on the front face 25 creates a field of view extending in front of the television 11.

The housing has an upper face 30 provided with an upper window 31 which is transparent to infrared radiation 14 and radio wave radiation 27. Behind the upper window 31 is an antenna 32 for receiving and transmitting radio waves 37, a transmitter-receiver circuit 33 for determining characteristics of the received radio waves (such as the particular frequency) and subsequently modulating radiowaves with those characteristics, and a memory 34 for storing those characteristics. There is also provided behind that window 31 a photodiode 36 for receiving infrared signals 14, a light emitting diode (LED) 37 for transmitting an infrared signal 35, an infrared transmitter-receiver circuit 38 for determining characteristics of the received infrared signals and for modulating infrared signals, a memory 39 for storing those characteristics of the infrared signals. There is also provided on the top of the housing a data entry button 40 which can be pressed to prompt the transmitter-receiver circuits to receive a new signal 14.

The underside of the housing (not shown) is provided with a battery compartment (not shown) which is closed by a removable cover and the batteries that are stowed in that compartment power the control unit.

A person responsible for the installation of the control device 10 presents the wireless remote control handset 12 to the upper window 31 on the upper face 30 of the housing 20. The power OFF button 15 on the handset 12 and the data entry button 40 adjacent the upper window 31 are then pressed simultaneously or in an appropriate sequence to cause a signal corresponding to the power off command to be transmitted by the handset 12 and received by the control device. When button 40 is pressed both memories 34,39 are cleared and one of the transmitter-receiver circuits recognises and demodulates the specific signal 14 and stores characteristics thereof in its respective memory.

The PID 21 is constantly monitoring the viewing field 26 in front of the television 11 and when people or animals occupy that viewing field their body heat is sensed by the sensor 22 which temporarily generates a voltage. In fact, every time a person occupying that viewing field moves sufficiently a voltage is generated. If a predefined period of time passes and no movement occurs then no heat will be sensed and no voltage will be generated. Consequently the PCB 23 signals to the infrared transmitter-receiver circuit 38 that the viewing field is unoccupied and the infrared transmitter-receiver circuit 38 then causes the LED 37 to transmit a signal emulating the off command signal stored in the memory 39, which causes the television 11 to switch off.

The control device 10 is fitted with an antenna 32 and radio wave transmitter-receiver circuit 33 to accommodate electrical items and handsets that communicate with radio waves. In the present example the television 11 and handset 12 communicate with infrared radiation 14 so the radio wave components were not used, though some electrical items use radio waves to communicate with their handsets so it is a useful feature.

A second embodiment of the invention is shown in FIGS. 3 and 4, though features of that invention which are common to the first embodiment will be accorded the same reference numbers as those in the first embodiment. This embodiment of the invention is adapted to accommodate a wireless remote control handset which issues an infrared signal or radio wave signal which represents two or more different commands. Usually, when a dual purpose signal is issued the intended command is obvious from the operational status of the electrical item to which it was conveyed. In view of this, the control device 50 of this second embodiment is adapted to determine the instantaneous operational status of the electrical item and respond accordingly.

FIG. 3 shows a control device 50 for communicating with an air conditioning unit 51 and its handset 52. The control device 50 comprises a housing 53 provided with window 31 on its upper face 54 and lens 24 on its front face 55. The antenna 32, radio wave transmitter-receiver circuit 33, memory 34, photodiode 36, LED 37, infrared transmitter-receiver circuit 38, memory 39 are disposed inside the housing 53, below the upper window 31. The PCB 23 carrying the sensor 22 is mounted behind the lens 24, much like the first embodiment. In addition, the control device 50 includes a status monitor generally indicated 60, which comprises a mains power cable 61 extending from the housing 53, a power sensing and comparator circuit 62 disposed within the housing and an output socket 63 provided on the front face 55 of the housing 53. The sensing and comparator circuit 62 is adapted to determine how much current is being drawn from the air conditioning unit 51 electrically connected to the output socket 63 and compare that value with a predetermined threshold value X corresponding to the maximum current drawn by the air conditioning unit 51 when in its standby mode. The sensing and comparator circuit 62 is configured to permit transmission of the emulated signal only when the measured current exceeds the threshold value X, thus indicating the air conditioning unit 51 as being in its on state.

Referring particularly to FIG. 4, the general process includes the first steps of receiving the specific signal 65 from the handset 52 and storing its characteristics in the memory 39. For the appropriate transmitter to issue an emulated signal two conditions must be satisfied. The first of those conditions is the field of view 26 being unoccupied, which is ascertained by a lack of body heat causing no voltage to be generated by the sensor 22 for a predetermined time, say 15 minutes. The second of those conditions is the air conditioning unit 51 being in the on state, which is detected by the sensing and comparator circuit 62 measuring a current value greater than the threshold value X, the threshold value X corresponding to the maximum current drawn by the air conditioning unit 51 when in its standby mode. A signal is sent from the PCB 23 and the sensing and comparator circuit 62 to both transmitter-receiver circuits 33,38, but only one of those will respond since only one has the characteristics of the specific signal 65 stored in its memory.

1. An air conditioning control device that automatically controls an electrical air conditioning unit which is operable by a wireless control unit adapted to issue a control signal corresponding to a particular command, the device comprising:
a first sensing means for detecting a first predetermined condition and issuing a first output signal indicative of said first predetermined condition being satisfied, the first predetermined condition being the absence or presence of a person or animal and the first sensing means comprising a motion sensor adapted selectively to detect one of those first predetermined conditions;
means for learning and storing the control signal issued by the wireless control unit which corresponds to the particular command;
a transmitter adapted selectively to transmit an emulated control signal matching that of the stored control signal on receipt of the output signal indicating the satisfaction of the first predetermined condition; and
second sensing means for detecting the operational status of the air conditioning unit and determining the power consumed thereby, the transmission of the emulated control signal depending also on said operational status.

2. (canceled)

3. An air conditioning control device as claimed in claim 1, wherein the motion sensor comprises a passive or active device.

4. An air conditioning control device as claimed in claim 1, wherein the first sensing means is adapted to operate intermittently for a predefined period of time.

5. (canceled)

6. An air conditioning control device as claimed in claim 1, wherein the second sensing means includes a preset condition comprising one of an on state and an off state and the transmitter is permitted to transmit the emulated control signal only when the operational status of the air conditioning unit is in the other of the on state and the off state, the emulated control signal corresponding to the power on command and the power off command.

7. (canceled)

8. An air conditioning control device as claimed in claim 1, and further comprising an electrical input for connection to an electrical power supply and an electrical output for connection to the air conditioning unit, the second sensing means being electrically connected to the electrical output to determine the power consumed.

9. An air conditioning control device as claimed in claim 1, wherein the second sensing means is also adapted to determine the temperature of the air conditioning unit.

10. An air conditioning control device as claimed in claim 1, wherein the second sensing means is also adapted to determine vibration characteristics associated with the air conditioning unit.

11. An air conditioning control device as claimed in claim 1, wherein the second sensing means is also adapted to determine the magnitude of any noise emitted from the air conditioning unit.

12. (canceled)

13. An air conditioning control device as claimed in claim 1, and further comprising a housing.

14. (canceled)

15. A method of controlling an air conditioning unit operable by a wireless control unit, comprising the steps of:
a) receiving a first control signal corresponding to a particular command and issued by the wireless control unit;
b) monitoring for a first predetermined condition, wherein the first predetermined condition is the absence or presence of a person or animal;
c) determining the operational status of the air conditioning unit and determining the power consumed thereby; and
d) on detection of the first predetermined condition, transmitting an emulated control signal equivalent to the first control signal so as to convey the particular command to the air conditioning unit, the transmission of the emulated control signal only occurring if the operational status of the air conditioning unit corresponds to a preset condition.

16. (canceled)
